(19) United States
(12) Patent Application Publication
(10) Pub. No.: US 2017/0254675 A1
(43) Pub. Date: Sep. 7, 2017

(54) CAPACITIVE AREA SENSOR

(71) Applicant: I.G. BAUERHIN GMBH, GRUENDAU (DE)

(72) Inventors: ALEXANDER HEIN, Fulda (DE); Klaus Flittner, Johannesberg (DE); Volker Letzas, Muenster (DE)

(21) Appl. No.: 15/426,217

(22) Filed: Feb. 7, 2017

(30) Foreign Application Priority Data
Mar. 7, 2016 (DE) 20 2016 001 419.7

(51) Int. Cl. G01D 5/241; B62D 1/06; B60R 21/015

(52) U.S. Cl. CPC G01D 5/241; B60R 21/01516; B62D 1/06

(57) ABSTRACT

A capacitive surface sensor for a vehicle seat or a steering wheel has at least one electrically insulating carrier layer and one electrically conductive layer allocated to each side of the carrier layer. The carrier layer is a three-dimensionally malleable layer and at least one of the electrically conductive layers forms a direct bond with the carrier layer.

### BACKGROUND OF THE INVENTION

The present invention relates to a capacitive area sensor, in particular for a motor vehicle seat or steering wheel.

Such capacitive area sensors, which are integrated into a vehicle seat or in a vehicle's steering wheel for example, form a part of a detection device, for example to register the occupancy condition of vehicle seat or to determine if a driver of a vehicle touches the steering wheel with his hand. In its fundamental structure, such an area sensor has at least one electrically insulating carrier layer and an electrically conductive layer assigned to each side of the carrier layer.

DE 10 2011 084 903 A1 describes sensor systems for motor vehicles, also to be installed on a steering wheel, which is additionally heatable with a heating device. The described steering wheel has a steering wheel rim with a metallic skeleton that is embedded in a layer of foam. This foam layer is surrounded by a heating layer, which in turn is enveloped by an electrically conductive shielding layer.

The shielding layer is surrounded by a sensor layer (a capacitive sensor element). On the outside the steering wheel rim is covered by a steering wheel cover. The shielding layer can have a multilayer construction, for example with a conductive layer of a wire mesh, one adhesive layer arranged above and one thereunder, a foam layer and a nonwoven. It is also provided that a heating conductor of a heating element and a sensor conductor of a sensor element are arranged on the two sides of the shielding layer. The integration of a nonwoven in the shielding element achieves that the wires for the heating conductor and for the sensor conductor are sewn together securely.

DE 203 09 877 U1 is directed to a vehicle safety system in which at least one capacitive sensor, preferably a plurality of sensors, are integrated in the steering wheel rim of a steering wheel. A change in an electrical or electromagnetic field is detected by means of the sensors. The sensors are located between the casing, for example embedded in PUR foam, of a steering wheel skeleton and a casing surrounding the steering wheel rim to the outside, in the form of a flexible foam layer, a leather or a wood casing. It is also provided that the sensors are formed by at least one section of a steering wheel heating system. When several sensors are used, conclusions can be drawn about the position of the upper body or the head of a driver relative to the axis of rotation of the steering wheel. The sensors can be constructed as a flexible mat with elongated electrical conductors accommodated therein. Such a sensor can also contain a nonwoven mat with wires interlaced therein.

DE 203 09 603 U1 describes a steering wheel for a motor vehicle. The steering wheel has a sensor device that is designed as a capacitive sensor element and is arranged in the region of the steering wheel rim of the steering wheel. This sensor device is used to detect the approach and/or contact of the steering wheel rim by a hand of a driver by changing the capacitance of the sensor element in order to also determine if the hand of a vehicle occupant is fully or only partly on the steering wheel or is even only in the vicinity of the steering wheel. The sensor device is located covered underneath a steering wheel cover or a steering wheel sheathing and is constructed of a conductor arrangement that is designed, for example, with an electrically conductive wire wound around the steering wheel rim. This conductor arrangement acts as a capacitive sensor device. The signals are detected by an electronic evaluation system, which can be arranged in the central steering wheel area. The sensor device can also be constructed in the form of a conductive plastic, or by flat ribbon conductors or by a three-dimensional, conductive mesh structure.

It is apparent that such capacitive area sensors should be very flexible in order to be able to adapt to the respective circumstances, for example on a steering wheel or inside a vehicle seat.

### SUMMARY OF THE INVENTION

The principal objective of the present invention is to provide a capacitive area sensor that is particularly suitable for applications in a vehicle seat or on a vehicle steering wheel, that is inexpensive to manufacture, and that has very flexible as well as better shielding properties.

This objective, as well as other objectives that will become apparent from the discussion that follows, are achieved, in accordance with the present invention, by providing a capacitive area sensor having at least one electrically insulating carrier layer and an electrically conductive layer assigned to each side of the carrier layer, and wherein the carrier layer is a three-dimensionally malleable layer and at least one of the electrically conductive layers forms a direct bond with the carrier layer.

The term “direct bond” between the carrier layer and the electrically conductive layer is intended to mean that the conductive layer is applied to the carrier layer without the use of an adhesive agent, that is, adhesive-free. This ensures a stable bond between the carrier layer and the conductive layer. This also ensures that the carrier layer and the conductive layer or the carrier layer and the two conductive layers, if one conductive layer each is applied directly on both sides of the carrier layer directly and adhesive-free, cannot move in relation to each during handling at the time of installation, but also during use in a vehicle. Consequently, no adhesive layers, for example in the form of a double-sided adhesive tape, are required between the carrier layer and the conductive layer.

In one embodiment, the respective conductive layer is formed by a lacquer that is applied in the required thickness to the one and/or the other side surface of the carrier layer. A spray head can be used to apply such a lacquer.

However, it is also provided that the conductive layer is applied in the form of a paste to the respective side of the carrier layer; a paste is particularly suitable when a thicker layer of a conductive material is to be produced on the carrier layer. When very thin conductive layers are to be produced on the carrier layer, the conductive layer is applied as a vapor-deposited layer. The production of such thin layers is known, among other terms as physical vapor deposition (PVD) or chemical vapor deposition (CVD).

Depending on whether the conductive layer is to be applied to the carrier layer as a lacquer or as a paste and also depending on the required thickness of the conductive layer, the respective conductive layer is applied by a brush-like applicator, by screen printing or by spraying onto the respective surface of the carrier layer.

It is provided that the respective conductive layer is a layer containing a precious metal or a precious metal alloy. Particularly preferable is that the respective conductive layer is a layer containing essentially silver. For example, the silver particles can be present in a finely distributed form in this layer. A suspension with finely distributed particles of conductive material can also be used for the application.

A further important aspect is that the carrier layer, which is a three-dimensionally malleable layer, has a surface with which the conductive layer can connect well. Essentially, the surface of the carrier layer should be smooth, and if the carrier layer has pores, these pores should be closed-porous at least in the region of the surface. Ethylene propylene diene (monomer) rubber (EPDM) is intended as the material for the carrier layer, which has all the properties that the carrier layer is supposed to have, such as, for example, good elastic properties and thus three-dimensional malleability, a smooth surface, and the like.

Alternatively, the carrier layer may be made from polyolefin, elastomer, preferably polyethylene, or preferably of silicone.

Furthermore, the carrier layer can alternatively be made from the group of polyesters, preferably polyethylene terephthalate (PET), or from the group of polyimides, preferably Kapton®, which is a trademark of DuPont.

A carrier layer of a foam material, preferably of polyurethane foam, has the advantage that three-dimensional malleability is very good, especially when this foam is closed-porous foam and this foam has a very small pore size.

It is provided that the respective electrically conductive layer has a thickness in the range of 1 nm to 100 μm, preferably a thickness of 10 nm to 50 μm, more preferably a thickness of 10 nm to 20 μm; this means that the conductive layer is preferably applied very thinly on the corresponding side of the carrier layer in order to thereby also achieve a compact design of a capacitive area sensor.

The respective electrically conductive layers may but do not need to have substantially identical resistance values. The resistance values are in a range from 0.06 Ohm/square to 600 Ohm/square, preferably from 6 Ohm/square to 60 Ohm/square, more preferably in a range from 0.1 Ohm/square to 10 Ohm/square and especially preferably in a range of 0.1 Ohm/square to 5 Ohm/square.

For certain areas of application, the respective electrically conductive layer has a smaller outer limit or circumference than the carrier layer so that the conductive layer is spaced apart from the edge of the carrier layer at least in partial areas.

In a further embodiment, the electrically conductive layer on one side of the carrier layer can be dimensioned smaller in its outer dimensions than the other electrically conductive layer on the other side of the carrier layer. Also, at least one of the electrically conductive layers can cover only partial areas of the carrier layer.

Different sizes of the electrically conductive layers are used to improve a shielding effect and to obtain a lower basic capacitance. Furthermore, this prevents a possible short circuit at the edge between the two electrically conductive layers.

Short circuits at the edge, between the electrically conductive layers and the carrier layer located therebetween, can also be avoided by conical or cone-shaped punching of the outer contour.

In a further possible embodiment, the one electrically conductive layer on the one side of the carrier layer can be divided into a plurality of regions that are electrically insulated against each other. The other electrically conductive layer on the other side of the carrier layer can also be divided into a plurality of regions which are each assigned to a region of the other electrically conductive layer or into only one region.

The separation into several areas is used to recognize and distinguish different positions of the driver's hands, such as, for example, touching the left or right side of the steering wheel or grasping the steering wheel. The same applies to different seat positions on a vehicle seat.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a cross-section of a capacitive area sensor according to a first embodiment.

FIG. 2 is a cross-section of a capacitive area sensor according to a second embodiment.

FIG. 3 is a schematic cross-section of the layer structure of a steering wheel.

FIG. 4 shows the layer structure of a heating layer, as can be used in FIG. 3.

FIG. 5 shows a further layer structure of a heating layer, as can be used in FIG. 3.

FIG. 6 shows a third layer structure of a heating layer, as can be used in FIG. 3.

FIGS. 7a to 7e show various details of different structures for electrically conductive layers.

### DESCRIPTION OF THE PREFERRED EMBODIMENTS

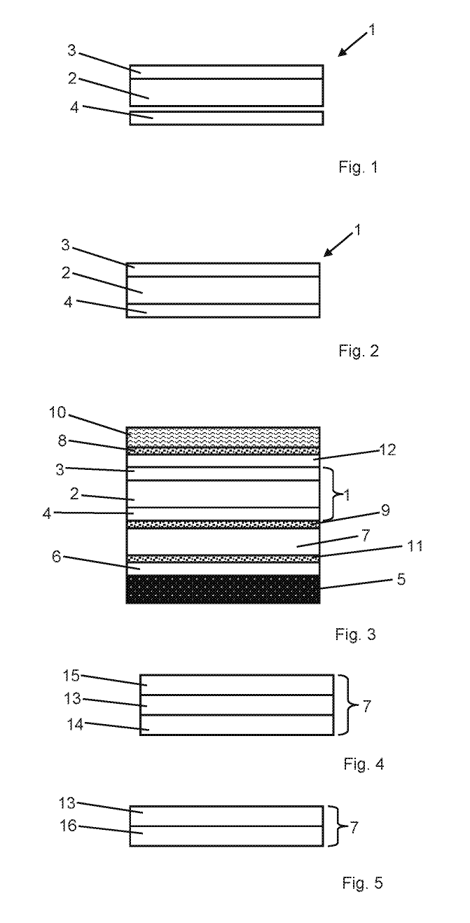

The preferred embodiments of the present invention will now be described with reference to FIGS. 1-7 of the drawings. Identical elements in the various figures are designated with the same reference numerals.

A capacitive area sensor according to the invention that is provided for use in a vehicle seat or in a steering wheel and is generally designated by reference numeral 1, comprises at least one electrically insulating carrier layer 2 and one respective electrically conductive layer 3, 4 assigned to each side of the carrier layer 2, as shown in FIG. 1.

The carrier layer 2 is made from a thin three-dimensionally malleable material, preferably from an ethylene propylene diene (monomer) rubber (EPDM), a polyolefin, an elastomer or foam, with polyurethane foam being preferred. If the carrier layer 2 consists of a foam material, it should be closed-porous foam, or at least foam with a small pore size.

The carrier layer 2 has a thickness in the range from 0.01 mm to 3 mm, with a thickness of 0.05 mm to 2 mm or from 0.07 mm to 1.5 mm being preferred in order to achieve a layer structure which is as thin as possible.

At least on one side of the carrier layer 2, the electrically conductive layer 3 assigned to this side is applied such that it has a direct, i.e., adhesive-free bond with the carrier layer 2. In order to obtain such a direct, adhesive-free bond, namely by avoiding an adhesive layer, the conductive layer 3 is applied as a lacquer or as a paste. It is also provided that the conductive layer 3 is vapor-deposited onto the respective side of the carrier layer 2 by means of PVD or CVD methods.

As FIG. 1 shows, the conductive layer 4, which is associated with the other surface side of the carrier layer 2, can only be placed on the carrier layer 2 (this is indicated in FIG. 1 by a gap between the carrier layer 2 and the conductive layer 4, which is otherwise not present).

FIG. 2 shows a capacitive area sensor 1 which corresponds in its layer structure to that shown in FIG. 1. However, in FIG. 2, the second sensor layer 4 is also a layer that is applied in a direct bond with the carrier layer 2, i.e., adhesive-free, in a manner as described above with reference to the conductive layer 3. The electrically conductive layer 3 and the electrically conductive layer 4 can have the same or different layer thicknesses, depending on the area of application of the capacitive area sensor 1.

For the respective conductive layer 3 or 4, a thickness of 1 nm to 100 μm, preferably a thickness of 1 nm to 50 μm, even more preferably a thickness of 1 nm to 20 μm, is intended. This results in a layer structure for the capacitive area sensor 1 with the carrier layer 2 and the two conductive layers 3 and 4 having a very small thickness, which may be approximately 1 mm, in particular depending on the thickness of the carrier layer 2.

Due to the materials used for the carrier layer 2 as described above, the carrier layer 2 has certain elasticity so that it is three-dimensionally malleable in order to adapt it to the circumstances, for example when the capacitive area sensor is placed around a steering wheel rim. It is also of particular advantage that the electrically conductive layers 3 and/or 4 are in direct, adhesive-free contact with the carrier layer 2, namely in a manner, in particular by the method of applying the conductive layers 3, 4 onto the carrier layer 2, that allows them to adapt to the stretching behavior of the carrier layer 2.

The conductive layer 3 and/or 4 can be produced by a lacquer, which is applied to the carrier layer 2 by means of a spray head, with the advantage that the layer thickness of the conductive layer 3 or 4 can be adjusted very precisely and the layer can also penetrate into uneven surfaces of the carrier layer 2, for example pores. After drying, the layer that is moist after the spraying process is intimately bonded to the carrier layer 2, in particular when the lacquer contains constituents that etch the surface of the carrier layer 2.

To obtain even thicker conductive layers 3 or 4 on the carrier layer 2, the respective conductive layer can be applied to the carrier layer 2 as a lacquer or paste by a brush-like applicator.

In particular, if the conductive layer is to be masked on the carrier layer 2, it can be applied by screen printing; however, an application by spraying or a paste application or an application by means of PVD or CVD methods using masks is also possible.

FIG. 3 shows a cross-section through the layer structure of a steering wheel in which the capacitive area sensor, as shown in FIGS. 1 and 2, is integrated.

Such a steering wheel has a steering wheel core 5, which is embedded in a foam jacket 6. A heating layer 7 is applied to the foam jacket 6 and glued to the foam jacket 6 via an adhesive layer 11, for example a double-sided adhesive tape. Located on the outer side of the heating layer 7 is the area sensor 1, which is also connected to the heating layer 7 via an adhesive layer 9, together with the carrier layer 2 and the two conductive layers 3 and 4 covering the carrier layer 2. The outer conductive layer 3 is covered by a steering wheel cover 10, which is glued to the area sensor 1 via a further adhesive layer 8. Optionally, a laminating layer 12, which serves to improve the haptics of the steering wheel, can be interposed between the area sensor 1 and the cover.

The capacitive area sensor 1 has very flexible properties due to the materials used for the carrier layer 2 and the conductive layers 3, 4, and can be produced with a very thin layer thickness.

It is to be pointed out that the Figures, in particular the layer thicknesses shown therein, are not to scale.

FIGS. 4 to 6 show various heating layers 7, as can be used in the layer structure of a steering wheel, which is illustrated in FIG. 3, or also in a vehicle seat.

In the structure shown in FIG. 4, a heating wire 13 is embedded between a lower foam layer 14 and an upper foam layer 15. The purpose of the upper foam layer 15 is to insulate the heating wire 13 from the electrically conductive layer 4 of the capacitive area sensor 1. A film of ethylene propylene diene rubber (EPDM), which is characterized by its elastic and well-insulating properties, is also preferably used for this layer.

In an alternative design as shown in FIG. 5, the heating layer 7 can also comprise only one heating wire 13, which is applied to a nonwoven 16 and is covered on its side facing the area sensor 1.

As shown in FIG. 6, the foam layer 14, as shown in the heating layer 7 of FIG. 4, can be replaced by a non-woven layer 17 on the side facing the steering wheel core 5.

A nonwoven fabric of polyester having a preferred thickness in the range from 0.5 mm to 1.5 mm is used, for example, as a non-woven layer 16 or 17, as shown in FIGS. 5 and 6.

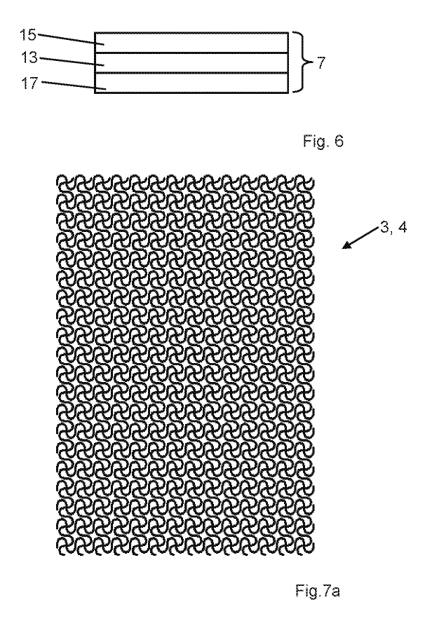

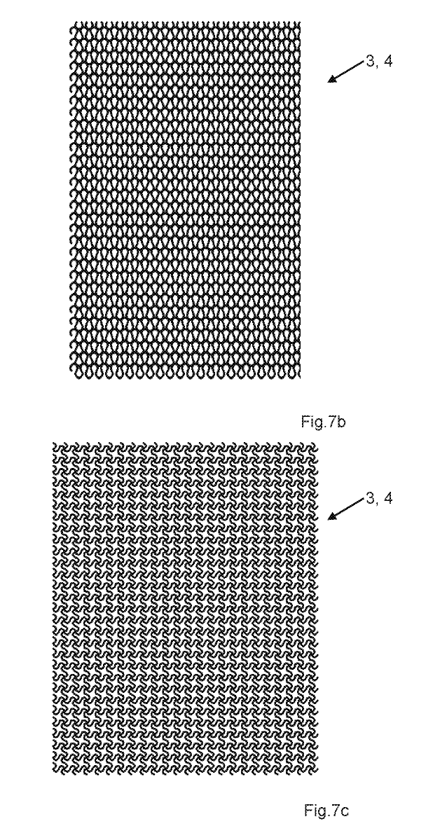

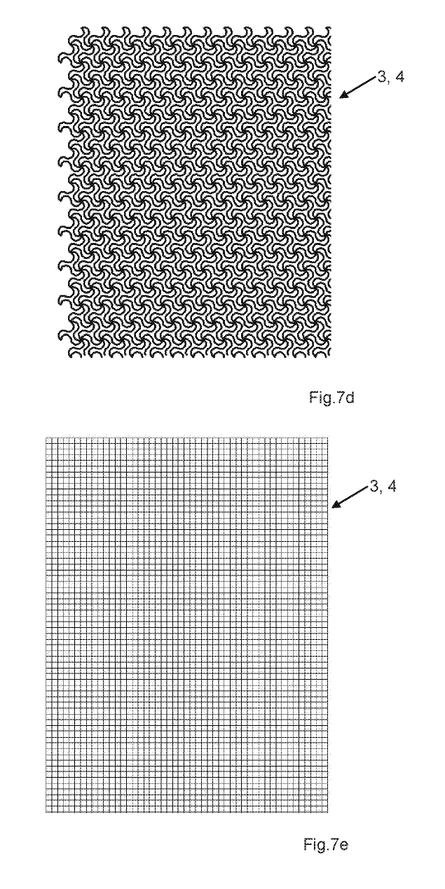

FIGS. 7a to 7e show various details of different structures for the electrically conductive layers 3 and 4, which can be applied to the carrier layer 2 by using corresponding masks. However, it is also provided that one of the electrically conductive layers 3 and 4 is connected as a metal foil with a respective structure as shown in FIGS. 7a to 7e to the carrier layer 2.

The metal foils, which in particular serve as a shielding layer on the lower side of the carrier layer 2, can have the form of meanders, star-shaped rays, and the like, in particular in the form of Greek meanders or Greek double meanders such that contiguous and thus interconnected electrical structures remain. Such patterns show a very good stretching behavior and thus a resilience, which can follow the stretching behavior of the carrier layer 2, such that they are particularly adapted to the conditions when used on a steering wheel or a seat.

The metal foils, which in particular serve as a shielding layer on the lower side of the carrier layer 2, can also have the form of a chessboard such that contiguous and thus interconnected electrically conductive structures remain.

There has thus been shown and described a novel capacitive area sensor which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

### REFERENCE NUMERAL LIST

1 Area sensor
2 Carrier layer
3 Electrically conductive layer
4 Electrically conductive layer
5 Steering wheel core
6 Foam jacket
7 Heating layer
8 Adhesive layer
9 Adhesive layer
10 Steering wheel cover
11 Adhesive layer
12 Laminating layer
13 Heating wire
14 Lower foam layer
15 Upper foam layer
16 Non-woven
17 Non-woven layer

What is claimed is:

1. A capacitive area sensor for a vehicle seat or a steering wheel having at least one electrically insulating carrier layer and one electrically conductive layer assigned to each side of the carrier layer, wherein the carrier layer is a three-dimensionally malleable layer and at least one of the electrically conductive layers forms a direct bond with the carrier layer.

2. Capacitive area sensor as in claim 1, wherein each respective electrically conductive layer forms a direct bond with each respective carrier layer on both sides of the carrier layer.

3. Capacitive area sensor as in claim 1, wherein each respective electrically conductive layer is formed by a lacquer.

4. Capacitive area sensor as in claim 1, wherein each respective electrically conductive layer is formed by a paste.

5. Capacitive area sensor as in claim 1, wherein each respective electrically conductive layer is a vapor-deposited layer.

6. Capacitive area sensor as in claim 1, wherein each respective electrically conductive layer is a layer applied by spraying.

7. Capacitive area sensor as in claim 1, wherein each respective electrically conductive layer is a layer applied by screen printing.

8. Capacitive area sensor as in claim 1, wherein each respective electrically conductive layer is a layer containing a precious metal or a precious metal alloy.

9. Capacitive area sensor as in claim 8, wherein each respective electrically conductive layer is a layer containing essentially silver.

10. Capacitive area sensor as in claim 1, wherein the carrier layer is formed from ethylene propylene diene (monomer) rubber (EPDM).

11. Capacitive area sensor as in claim 1, wherein the carrier layer is formed of polyolefin.

12. Capacitive area sensor as in claim 1, wherein the carrier layer is formed of a plastic foam.

13. Capacitive area sensor as in claim 1, wherein each respective electrically conductive layer has a thickness in the range of 1 nm to 100 μm.

14. Capacitive area sensor as in claim 1, wherein each respective electrically conductive layer has a smaller outer limit than the carrier layer.

15. Capacitive area sensor as in claim 1, wherein one of the electrically conductive layers is smaller in its outer dimensions than the other electrically conductive layer.

16. Capacitive area sensor as in claim 12, wherein the carrier layer is formed of a polyurethane foam.

17. Capacitive area sensor as in claim 13, wherein each respective electrically conductive layer has a thickness in the range from 1 nm to 50 μm.

18. Capacitive area sensor as in claim 1, wherein each respective electrically conductive layer has a resistance value in a range from 0.06 Ohm/square to 600 Ohm/square.

19. Capacitive area sensor as in claim 19, wherein each respective electrically conductive layer has a resistance value in a range from 6 Ohm/square to 60 Ohm/square.

20. Capacitive area sensor as in claim 19, wherein each respective electrically conductive layer has a resistance value in a range from 0.1 Ohm/square to 10 Ohm/square.
